(19) United States
(12) Patent Application Publication
(10) Pub. No.: US 2025/0060270 A1
(43) Pub. Date: Feb. 20, 2025

(54) TESTING FOR AN AIR LEAK IN A CONTROLLED ATMOSPHERE CONTAINER

(71) Applicant: Maersk Container Industry A/S, Tinglev (DK)

(72) Inventor: Elisa Skytte GRIGOLEIT, Tinglev (DK)

(21) Appl. No.: 18/935,329

(22) Filed: Nov. 1, 2024

Related U.S. Application Data
(63) Continuation of application No. PCT/EP2023/061882, filed on May 4, 2023.

(30) Foreign Application Priority Data
May 5, 2022 (DK) PA202200427

(51) Int. Cl. G01M 3/02; F25D 29/00

(52) U.S. Cl. CPC G01M 3/02; F25D 29/003

(57) ABSTRACT

Provided is a controlled atmosphere container controller for a controlled atmosphere container. The controlled atmosphere container comprises a cargo space for storing cargo, and the controller is configured to perform a test for an air leak in the controlled atmosphere container. The test comprises the controlled atmosphere container controller causing a first characteristic of an atmosphere in the cargo space to have a first value, stopping causing the first characteristic to have the first value, receiving, in a time period following the stopping, a signal from a sensor configured to sense a second characteristic of the atmosphere in the cargo space, the signal representative of a value of the second characteristic of the atmosphere in the cargo space during the time period, and performing an action to permit determination of an air leak in the controlled atmosphere container, on the basis of the signal.

### CROSS-REFERENCE TO RELATED APPLICATIONS

This application is a continuation under 35 U.S.C. § 120 of International Application No. PCT/EP2023/061882, filed May 4, 2023, which claims priority to Denmark (DK) Application No. PA202200427, filed May 5, 2022 under 35 U.S.C. § 119(a). Each of the above-referenced patent applications is incorporated by reference in its entirety.

### TECHNICAL FIELD

The present invention relates to a controlled atmosphere container controller configured to perform a test for an air leak in a controlled atmosphere container. The present invention also relates to a method and a kit of parts for performing the test, a controlled atmosphere container comprising the controlled atmosphere container controller, and a marine vessel comprising the controlled atmosphere container controller or the controlled atmosphere container.

### BACKGROUND

Many types of cargo may be stored in containers comprising an atmosphere control system for controlling an atmosphere in the container. Such containers may be referred to as controlled atmosphere containers. Such controlled atmosphere containers include transportable storage units, or transport units, for transporting cargo on container vessels. These may be used to facilitate the storage and transportation of perishable goods, such as fruit, vegetables, or fresh or frozen meat or fish, or other goods, such as medicaments, in the transport unit. Such transport units include reefer containers, which may be TEU or 2-TEU containers designed to be shipped on container vessels, road vehicles, or railway wagons, and/or may be refrigerated trucks or trailers. Controlled atmosphere containers also include storage units used for storing and/or ripening goods in a warehouse, such as a ripening warehouse.

While a curtain may be fit over doors of a controlled atmosphere container in an attempt to seal the container, most controlled atmosphere containers are not completely air-tight. This means that, over time, an atmosphere surrounding a controlled atmosphere container may leak into the container, and/or the controlled atmosphere in the container may leak out of the container. It is desirable to limit the leakage rate of air into the container. If the leakage rate becomes too high, it may become more difficult to control the atmosphere in the container. This could reduce an efficiency of the controlled atmosphere container, and/or lead to spoilage of cargo being transported in the container.

### SUMMARY

According to a first aspect of the present invention, there is provided a controlled atmosphere container controller for a controlled atmosphere container, the controlled atmosphere container comprising a cargo space for storing cargo, the controlled atmosphere container controller configured to perform a test for an air leak in the controlled atmosphere container, the test comprising the controlled atmosphere container controller: causing a first characteristic of an atmosphere in the cargo space to have a first value; stopping causing the characteristic to have the first value; receiving, in a time period following the stopping, a signal from a sensor configured to sense a second characteristic of the atmosphere in the cargo space, the signal representative of a value of the second characteristic of the atmosphere in the cargo space during the time period; and performing an action to permit an air leak in the controlled atmosphere container to be determined on the basis of the signal.

In this way, the controlled atmosphere container controller may perform the air leak test when the controlled atmosphere container is in-use, such as when the controlled atmosphere container is in-transit, such as on a container ship. As such, the test may be performed when the controlled atmosphere container is being used to transport goods, such as perishable produce, in the cargo space. The test may also be performed automatically and/or remotely, such as without requiring maintenance personnel to be present and/or ancillary equipment to be provided. In this way, the container may not need to be taken out-of-use to perform the test. The test may also be performed more regularly, and/or in response to a suspected air leak in the controlled atmosphere container, such as in the event that the controlled atmosphere container is unable to, or is struggling to, maintain a desired controlled atmosphere in the cargo space.

By the controlled atmosphere container controller being able to perform the air leak test as and when needed, a potential air leak may be identified sooner, while an amount of downtime during which the container is unusable may be reduced. A cost of performing the test may similarly be reduced or eliminated. Moreover, the controlled atmosphere container may be tested more regularly, and/or plural controlled atmosphere containers in a fleet may be tested simultaneously. This may improve an efficiency of the controlled atmosphere container and/or the fleet, as air leaks may be identified and rectified with more case.

It will be understood that an “air leak” may include an external atmosphere outside of the cargo space and/or the controlled atmosphere container, which may be atmospheric air surrounding the controlled atmosphere container, leaking into the cargo space, such as through gaps in the controlled atmosphere container. An “air leak” may also include the atmosphere in the cargo space leaking outside the cargo space and/or the controlled atmosphere container through such gaps. The controlled atmosphere container may not be completely air tight. As such, the determination of the “air leak” herein may, in many examples, refer to a determination of an air leak above a permissible air leak threshold.

The controlled atmosphere container controller may herein be referred to as “the controller”.

Optionally, the first characteristic comprises a pressure of the atmosphere in the cargo space. Optionally, the first value is different to a value of a pressure of an external atmosphere outside of the cargo space. In other words, the causing the first characteristic to have the first value may comprise causing the atmosphere to have a pressure different to that of the external atmosphere.

Optionally, the causing the atmosphere in the cargo space to have the first value comprises the controller changing, such as reducing, the pressure of the atmosphere in the cargo space. Optionally, the first value is lower than the value of the pressure of the external atmosphere. The changing the pressure of the atmosphere in the cargo space may comprise reducing the pressure of the atmosphere relative to the pressure of the external atmosphere. Alternatively, the first value may be higher than the value of the pressure of the external atmosphere. In some such cases, the changing the pressure of the atmosphere in the cargo space may comprise increasing the pressure of the atmosphere relative to the pressure of the external atmosphere.

In some examples, the controller causing the pressure of the atmosphere in the cargo space to have the first value may be by the controller causing a temperature of the atmosphere to have a first temperature value. In other words, the temperature of the atmosphere in the cargo space may be caused to be changed to cause the pressure of the atmosphere in the cargo space to be changed. For example, the test may comprise the controller causing a reduction in temperature of the atmosphere in the cargo space, such as in a cooling mode of the atmosphere control system, so as to cause a corresponding reduction in pressure of the atmosphere in the cargo space. Similarly, the test may comprise the controller causing an increase in temperature of the atmosphere, such as in a heating mode of the atmosphere control system, so as to cause a corresponding increase in pressure of the atmosphere in the cargo space.

Optionally, the first characteristic comprises a temperature of the atmosphere in the cargo space. Optionally, the first characteristic comprises a composition of the atmosphere in the cargo space, such as a level of oxygen and/or carbon dioxide in the cargo space.

It will be appreciated that the controller causing the first characteristic to have the first value may comprise the controller causing the controlled atmosphere container, and/or an atmosphere control system thereof, to operate in a mode of operation, such as a cooling mode or a heating mode, and/or a mode in which a composition of the atmosphere in the cargo space is controlled. This may cause the pressure and/or temperature of the atmosphere in the space to have the first value, such as to change, during the mode of operation. This may in turn cause a difference in pressure and/or temperature between the atmosphere in the cargo space and the external atmosphere outside the cargo space during operation of the controlled atmosphere container in the mode of operation. The controller stopping the causing the first characteristic to have the first value may comprise the controller stopping operating the controlled atmosphere in the mode of operation, such as by stopping the controlled atmosphere container causing a cooling or heating of the atmosphere in the cargo space.

Optionally, the second characteristic comprises the first characteristic. For instance, both the first and second characteristics may comprise a pressure of the atmosphere in the cargo space. In this way, the test may comprise the controller causing the pressure of the atmosphere in the cargo space to have the first value, which may be by causing a reduction and/or an increase in the pressure and/or the temperature in the cargo space as described above. The test may then comprise the controller stopping the causing the pressure to have the first value. The signal received by the controller in the time period following the stopping may then be representative of a value of the pressure of the atmosphere in the cargo space during the time period following the stopping. The test may comprise the controller monitoring the received signal, such as to monitor a change in pressure following the stopping. Such a change in pressure may be indicative of an air leak in the controlled atmosphere container.

Alternatively, the second characteristic may not comprise the first characteristic, and/or may be other than the first characteristic. For instance, one of the first and second characteristics may be, or may comprise, a pressure of the atmosphere, and the other of the first and second characteristics may be, or may comprise, a composition and/or a temperature of the atmosphere. This may be particularly beneficial where the cargo comprises ripenable produce, which may reduce a level of O2 in the atmosphere during ripening. In this way, a potential air leak may be detected when an external atmosphere outside of the cargo space having a higher O2 content than the atmosphere in the cargo space leaks into the controlled atmosphere container, thereby increasing a level of O2 in the atmosphere in the cargo space following the stopping. More generally, it will be understood that each of the first and second characteristics may be, or may comprise, any suitable characteristic described herein, which may be the same characteristic or different characteristics.

Optionally, the controlled atmosphere container controller performing the action comprises the controlled atmosphere container controller comparing the value of the second characteristic during the time period to the first value. For instance, the action may comprise determining to what extent the value of the second characteristic is departed from the first value in the time period following the stopping. In the event of an air leak, the second characteristic may depart from the first characteristic more quickly following the stopping.

Optionally, the action comprises the controller comparing the value of the second characteristic to a threshold second characteristic, and/or to an equalised characteristic. The threshold second characteristic may comprise a value of pressure, temperature and/or composition that a controlled atmosphere container having an acceptable rate of air leakage would expect to reach after a given period of time, as will be described in more detail below. Alternatively, or in addition, the threshold second characteristic and/or the equalised characteristic may comprise a value of pressure, temperature and/or composition that the controlled atmosphere container may be expected to attain “at rest”, such as when it is not operated in a mode of operation as described above. The equalised characteristic may comprise a value of pressure, temperature and/or composition that the controlled atmosphere container may be expected to reach if it were not sealed, such as if doors of the controlled atmosphere container were to be opened.

The equalised characteristic may be reached when a pressure, temperature and/or composition of the atmosphere in the cargo space is equalised with that of the external atmosphere introduced above. In the event of an air leak, the atmosphere in the cargo space may reach such an equalised state more quickly than if the container were to be air-tight. The threshold second characteristic may be a value between the first characteristic and the equalised characteristic. This may be a value half-way between the first characteristic and the equalised characteristic. Optionally, the threshold second characteristic is any other suitable value between the first characteristic and the equalised characteristic. For example, the threshold second characteristic may be distanced from the first characteristic or distanced from the equalised characteristic by an amount that is less than or greater than one-third, or less than or greater than one-quarter of the difference between the first characteristic and the equalised characteristic. In this way, a potential air leak in the controlled atmosphere container may be detected or determined when the value of the second characteristic during the time period following the stopping exceeds, reduces below, and/or is within a tolerance of, the threshold second characteristic.

Optionally, the test comprises the controlled atmosphere container controller receiving, during the test, a further signal from the sensor or a further sensor, the further signal representative of a further value of the second characteristic during the test. Optionally, the performing the action comprises comparing the value of the second characteristic during the time period to the further value of the second characteristic during the test.

Optionally, the further signal is received before, at, and/or during the time period following, the stopping causing the characteristic to have the first value. Optionally, the further value is a further value before, at, and/or during the time period following, the stopping the causing the characteristic to have the first value.

Optionally, the performing the action comprises determining a change in the value of the second characteristic during the time period. This may be, for example, on the basis of the comparing the value of the second characteristic during the time period to the first value, and/or to the further value of the second characteristic. Optionally, the performing the action comprises comparing the change in the second characteristic to a threshold change in the second characteristic.

Optionally, the performing the action comprises determining a time taken, following the stopping, for the second characteristic to meet, exceed or reduce below the threshold second characteristic introduced above. Optionally, the performing the action comprises determining a time taken, following the stopping, for the change in the value of the second characteristic during the time period to meet, or exceed, a threshold change in the value of the second characteristic. Optionally, the performing the action comprises comparing the time taken to a threshold time, which may be representative of an acceptable amount time for the second characteristic to reach the threshold second characteristic. When an unacceptable air leak is present, the second characteristic may tend towards the equalised threshold more quickly than when no air leak is present, or when an acceptable air leak is present. As such, a potential air leak may be identified if the time taken meets, or reduces below, the threshold time.

Optionally, the controller performing the action comprises the controller monitoring the value of the second characteristic during the time period following the stopping, such as intermittently and/or continuously. In other words, the controller may determine the value of the second characteristic at plural times following the stopping, such as on the basis of the signal and/or the further signal. The controller may then compare the second characteristic at one or more of the plural times to the first value, to the threshold second characteristic, to the equalised characteristic, and/or to the one or more further values of the second characteristic.

Optionally, the action comprises determining that there is, or may be, an air leak in the controlled atmosphere container. This may be, for instance by the controller determining that: the value of the second characteristic has met, exceeded, or reduced below the threshold second characteristic; the change in the second characteristic has met, or exceeded, the threshold change in the second characteristic; the time taken for the second characteristic to meet, exceed, or reduce below the threshold second characteristic, or the time taken for the change in the second characteristic to meet, or exceed, the threshold change in the second characteristic, has met, or reduced below, the threshold time.

Optionally, the action comprises transmitting any one of the values or determined qualities described above. These values or determined qualities include: the first value; the value of the second characteristic during the time period; the further value of the second characteristic; the change in the second characteristic; the time taken for the second characteristic to meet, exceed, or reduce below the threshold second characteristic; the time taken for the change in the second characteristic to meet, or exceed, the threshold change in the second characteristic; and the result of the determination that there is, or may be, a leak in the controlled atmosphere container. The transmitting may be, for example, to a user device and/or to another controller, such as another controller of the controlled atmosphere container, and/or a controller of a remote control system remote from the controlled atmosphere container. This may allow a user at a remote location to take remedial action in response to a potential air leak, such as to flag the container for further inspection, and/or to cause the controlled atmosphere container to operate in a different way, such as to adjust a level of cooling of the atmosphere in the cargo space.

Optionally, the action comprises saving any one of the values or determined qualities described above to memory. These values or determined qualities include: the first value; the value of the second characteristic during the time period; the further value of the second characteristic; the change in the second characteristic; the time taken for the second characteristic to meet, exceed, or reduce below the threshold second characteristic; the time taken for the change in the second characteristic to meet, or exceed, the threshold change in the second characteristic; and the result of the determination that there is, or may be, a leak in the controlled atmosphere container. The memory may be, for example, a memory of the controlled atmosphere container controller, a memory of the controlled atmosphere container, a memory of a user device, and/or a memory of a remote control system remote from the controlled atmosphere container. This may allow the development of an air-leak in the controlled atmosphere container to be tracked over time, such as over subsequent tests. This may permit anticipatory remedial action to be taken, such as in the event that a rate of such an air-leak is observed to increase in a short space of time. This may allow an efficiency of the controlled atmosphere container to be maintained or improved.

Optionally, the action comprises displaying the first value, the value of the second characteristic during the time period, and/or the further value of the second characteristic. The displaying may be, for example, on a display of the controlled atmosphere control system, a display of a user device, and/or a display of a remote control system remote from the controlled atmosphere container. This may allow a user to quickly identify whether there is an air leak in the controlled atmosphere container and take appropriate remedial action.

Optionally, the action comprises determining a rate of leakage of the external atmosphere into the cargo space and/or a rate of leakage of the atmosphere in the cargo space out of the cargo space. This rate of leakage may be determined on the basis of a rate of change of the second characteristic, such as pressure, in the cargo space, and/or based on a free volume in the cargo space. The free volume in the cargo space may be a volume in the cargo space that contains the atmosphere in the cargo space. That is, the free volume may be a volume which is not taken up by cargo or other items in the cargo space. Optionally, the free volume is predetermined. Optionally, the free volume is defined when the cargo space is loaded with cargo, such as by a user. Optionally, the free volume is estimated, such as based on a typical free volume when the controlled atmosphere container is loaded with cargo, in use.

Optionally, the controller is configured to, in the event of a determination of an air leak in the container, such as in response to the rate of leakage exceeding a rate of leakage threshold, issuing an signal indicative of an air leak in the container. The issuing a signal indicative of an air leak may comprise triggering an alarm, or an alert, to alert a user, such as maintenance personnel, to the present of an air leak in the controlled atmosphere container. The alert may allow the user to take remedial action in response to the determined air leak, such as to take the container out of use, and/or to control an atmosphere in the container to compensate for the air leak. This may improve a quality of cargo stored in the controlled atmosphere container, even in the event of an air leak.

Optionally, the controlled atmosphere container controller is configured to perform the test when the controlled atmosphere container is in use, such as when ripenable produce is being stored or ripened in the container, such as in a ripening warehouse or during transit of the controlled atmosphere container.

Optionally, the controlled atmosphere container controller is configured to perform the test in response to a composition of the atmosphere meeting one or more predetermined composition criteria. The one or more predetermined composition criteria may comprise a level of O2 and/or CO2 reaching a respective O2 and/or CO2 threshold, which may be a predetermined O2 and/or CO2 threshold. This may be particularly beneficial when the cargo in the cargo space is perishable produce, and particularly respiring produce, such as bananas, which may ripen over time. In respiring, the produce may change a composition of the atmosphere in the cargo space, such as by consuming O2 and emitting CO2. In this way, the predetermined O2 and/or CO2 threshold may be reached when the produce begins respiring, such during transit, and/or that the produce has reached a predetermined stage of ripeness. This may be indicative that the controlled atmosphere container is sealed and/or is in operation to control the atmosphere in the cargo space, as such a change in the composition of the atmosphere may not occur. This may allow the test to be performed automatically, such as without user interference, during each use of the controlled atmosphere container, for example each time the composition reaches the predetermined composition threshold.

Optionally, the controlled atmosphere container controller is configured to perform the test in response to an initiation signal, such as an initiation signal received from another control system, such as a control system of the controlled atmosphere container, or a control system remote from the controlled atmosphere container. Optionally, the initiation signal is received from a user, such as maintenance personnel, such as via a user device or via a control interface of the controlled atmosphere container. In this way, the test may be initiated by the user, such as by sending a signal remotely, and/or by operating a control interface of the controlled atmosphere container. This may allow the air leak test to be readily performed in response to a suspected air-leak, and/or during routine maintenance.

Optionally, the controlled atmosphere container comprises a valve configurable to open into the cargo space, such as into the atmosphere in the cargo space. Optionally, the controlled atmosphere container comprises a pump arranged to fluidically couple the valve to an external atmosphere outside the cargo space. Optionally, the controlled atmosphere container controller is configured to cause the first characteristic to have the first value by causing the valve to open into the cargo space and/or by causing the pump to operate, such as to fluidically couple the atmosphere in the cargo space to the external atmosphere. Optionally, the controlled atmosphere container controller is configured to stop the causing the first characteristic to have the first value by causing the valve to close, and/or by causing the pump to stop operating, such as to fluidically decouple the atmosphere in the cargo space from the external atmosphere.

Optionally, the controlled atmosphere container comprises a filter (such as a membrane) configured to permit fluid flow therethrough to adjust a composition of the atmosphere in the cargo space. Optionally, the pump is arranged to couple both the filter and the valve to the external atmosphere. That is, the pump may be operable to pump the atmosphere from the cargo space to the external atmosphere via one or both of the valve and the filter. In other words, the valve and the filter are connected to the pump in a parallel fluid arrangement. In this way, the pump may be able to create a greater pressure difference between the atmosphere in the cargo space and the external atmosphere by extracting the atmosphere through the valve, rather than through the filter alone. This is because a flow rate through the filter may be restricted as the atmosphere is filtered through the filter. It will be appreciated that the filter and the valve may be fluidically connected, or connectable, to the cargo space and/or the external atmosphere outside the cargo space in a parallel fluid arrangement with each other, without requiring the pump. Moreover, the valve may be fluidically connected, or connectable, between the cargo space and the external atmosphere in a parallel fluid arrangement to both the filter and the pump. For instance, the valve may be operable to couple the cargo space with the external atmosphere while bypassing both the filter and the pump. In some such examples, the valve may be coupled to a further pump operable to cause the atmosphere in the cargo space to move through the valve and into the external atmosphere outside the cargo space, or from the external atmosphere into the cargo space via the valve.

A second aspect of the present invention provides a controlled atmosphere container comprising the controlled atmosphere container controller of the first aspect and the cargo space for storing cargo.

Optionally, the controlled atmosphere container comprises a valve configurable to open into the space, such as into the atmosphere in the cargo space. Optionally, the controlled atmosphere container comprises a pump arranged to couple the valve to an external atmosphere surrounding the controlled atmosphere container. Optionally, the controlled atmosphere container comprises a filter (such as a membrane) configured to permit fluid flow therethrough to adjust a composition of the atmosphere in the cargo space. Optionally, the pump is arranged to couple both the filter and the valve to the external atmosphere. That is, the pump may be operable to pump the atmosphere from the cargo space to the external atmosphere via one or both of the valve and the filter. It will be appreciated that the filter and the valve may be fluidically connected, or connectable, to the cargo space and/or the external atmosphere outside the cargo space in a parallel fluid arrangement with each other, without requiring the pump. Moreover, the valve may be fluidically connected, or connectable, between the cargo space and the external atmosphere in a parallel fluid arrangement to both the filter and the pump. For instance, the valve may be operable to couple the cargo space with the external atmosphere while bypassing both the filter and the pump. In some such examples, the valve may be coupled to a further pump operable to cause the atmosphere in the cargo space to move through the valve and into the external atmosphere outside the cargo space, or from the external atmosphere into the cargo space via the valve.

The controlled atmosphere container controller may be configured to cause the valve to open, and/or to cause the pump to operate, to cause the first characteristic to have the first value. This may be to reduce a pressure of the atmosphere in the cargo space, such as relative to a pressure of an external atmosphere outside of the cargo space. The controlled atmosphere container controller may be configured to stop the causing the first characteristic to have the first value by causing the valve to close and/or by causing the pump to stop operating.

Optionally, the controlled atmosphere container comprises the sensor from which the signal and/or the further signal is received. Optionally, the controlled atmosphere container comprises the further sensor, where provided. Optionally, the sensor and/or the further sensor is located in the cargo space. Alternatively, the sensor and/or the further sensor may be located in any other suitable location.

Optionally, the controlled atmosphere container, and/or a controller thereof, may be configured to issue the initiation signal received by the controlled atmosphere container controller. Particularly, the initiation signal may be issued in the event that an efficiency and/or capacity of the controlled atmosphere container, or an atmosphere control system thereof, reduces below a respective threshold capacity and/or threshold efficiency. The capacity may be a cooling and/or heating capacity of the controlled atmosphere container, or the atmosphere control system. The capacity may be reduced in the event of an air leak, as an atmosphere leaking into and/or out of the cargo space tends to “equalise” the pressure, temperature and/or composition of the atmosphere in the cargo space, as described above. The efficiency of the controlled atmosphere container, or the atmosphere control system, may similarly reduce as an amount of energy required to maintain the controlled atmosphere in the cargo space increases, which may be the case in the event of an air leak. In this way, the initiation signal may be issued to cause the controlled atmosphere container controller to perform the test in the event that the controlled atmosphere container and/or the atmosphere control system thereof is struggling to maintain the controlled atmosphere in the cargo space. Optionally, the controlled atmosphere container controller itself is configured to determine the capacity and/or efficiency of the controlled atmosphere container and/or the atmosphere control system, and to initiate the test in response to the capacity and/or efficiency reducing below the respective threshold capacity and/or threshold efficiency.

The controlled atmosphere container may be a transport unit, such as a transport unit for transporting perishable and/or respiring goods (such as fresh and/or frozen produce) in the cargo space. The controlled atmosphere container may be transportable on a vehicle, such as a marine vessel, a truck, or a train. The controlled atmosphere container may be reefer container, or a refrigerated truck or trailer. Optionally, the controlled atmosphere container is a ripening unit, such as for use in a ripening warehouse. Optionally, the controlled atmosphere container comprises a curtain for sealing, or at least partially sealing, a door into the controlled atmosphere container.

It will be appreciated that the controlled atmosphere container may benefit from any of the advantages and optional features ascribed to the controlled atmosphere container controller of the first aspect.

A third aspect of the present invention provides a kit of parts for performing a test for an air leak in a controlled atmosphere container, the kit of parts comprising: the controlled atmosphere container controller of the first aspect, wherein the controlled atmosphere container comprises the cargo space for storing cargo; and a valve configurable to selectively fluidically couple the cargo space with an external atmosphere outside the cargo space.

Optionally, the kit of parts is for performing a test for an air leak in the controlled atmosphere container of the second aspect. Optionally, the controlled atmosphere container of the second aspect comprises the kit of parts. It will be appreciated that the kit of parts may benefit from any of the optional features and advantages ascribed to the first and/or second aspects. In particular, the kit of parts may comprise the pump, the filter, the sensor from which the signal and/or the further signal is received, and/or the further sensor described above.

The kit of parts may advantageously be retrofit to an existing controlled atmosphere container, such as by fitting any one or more of the controlled atmosphere container controller, the valve, the pump, the filter, the sensor and/or the further sensor to the controlled atmosphere container. This may be particularly advantageous where the controlled atmosphere container already comprises the filter and the pump, in which case the valve can be readily fit to a line connecting the filter and the pump, for example. This may allow the valve to be opened to increase a flow rate of the atmosphere out of the cargo space, which may otherwise be restricted by the filter. This may allow a greater pressure difference to be achieved between the atmosphere and the external atmosphere, thereby increasing an accuracy of the air leak test.

A fourth aspect method of performing a test for an air leak in a controlled atmosphere container, the controlled atmosphere container comprising a controller and a cargo space for storing cargo, the method comprising the controller: causing a first characteristic of an atmosphere in the cargo space to have a first value; stopping causing the characteristic to have the first value; receiving, in a time period following the stopping, a signal from a sensor configured to sense a second characteristic of the atmosphere in the cargo space, the signal representative of a value of the second characteristic of the atmosphere in the cargo space during the time period; and performing an action to permit determination of an air leak in the controlled atmosphere container, on the basis of the signal.

Optionally, the controller is the controlled atmosphere container controller of the first aspect. Optionally, the controlled atmosphere container is the controlled atmosphere container of the second aspect.

The method may comprise any of the optional actions that the controlled atmosphere container controller of the first aspect is configured to perform. As such, it will be appreciated that the method may benefit from any of the optional features and advantages ascribed to the controlled atmosphere container controller of the first aspect, the controlled atmosphere container of the second aspect, and/or the kit of parts of the third aspect.

A fifth aspect of the present invention provides a non-transitory computer-readable storage medium storing instructions that, when executed by a processor of a controlled atmosphere container controller, cause the processor to carry out the method according to the fourth aspect.

It will be appreciated that the non-transitory computer-readable storage medium may benefit from any of the optional features and/or advantages of any of the first to fourth aspects. Particularly, the processor may be a processor of the controlled atmosphere container controller of the first aspect. That is, the controlled atmosphere container controller of the first aspect may comprise a processor configured to execute instructions that cause the processor to carry out the method of the fourth aspect.

A sixth aspect of the present invention provides a marine vessel comprising the controlled atmosphere container controller of the first aspect, the controlled atmosphere container of the second aspect, the kit of parts of the third aspect, or the non-transitory computer-readable storage medium of the fifth aspect.

It will be appreciated that the marine vessel may benefit from any of the optional features and/or advantages of any of the first to fifth aspects.

A seventh aspect of the present invention provides a controlled atmosphere container comprising: a cargo space for storing cargo; a filter (such as a membrane) configured to permit fluid flow to adjust a composition of the atmosphere in the cargo space, the filter opening into the cargo space; a valve opening into the cargo space; and a pump coupled to the valve and the filter and operable to cause the atmosphere in the cargo space to move through the filter and/or the valve and into an external atmosphere outside of the cargo space.

In other words, the valve and the filter are connected to the pump in a parallel fluid arrangement. In this way, the pump may be able to create a greater pressure difference between the atmosphere in the cargo space and the external atmosphere by extracting the atmosphere through the valve, rather than through the filter alone. This is because a flow rate through the filter may be restricted as the atmosphere is filtered through the filter.

It will be appreciated that the filter and the valve may be fluidically connected, or connectable, to the cargo space and/or the external atmosphere outside the cargo space in a parallel fluid arrangement with each other, without requiring the pump. Moreover, the valve may be fluidically connected, or connectable, between the cargo space and the external atmosphere in a parallel fluid arrangement to both the filter and the pump. For instance, the valve may be operable to couple the cargo space with the external atmosphere while bypassing both the filter and the pump. In some such examples, the valve may be coupled to a further pump operable to cause the atmosphere in the cargo space to move through the valve and into the external atmosphere outside the cargo space, or from the external atmosphere into the cargo space via the valve.

Optionally, the controlled atmosphere container comprises the controller of the first aspect. It will be understood that the controlled atmosphere container of the seventh aspect may comprise any of the optional features of the controlled atmosphere container of the second aspect. Similarly, the controlled atmosphere container of the seventh aspect may benefit from any of the advantages ascribed to the controlled atmosphere container of the second aspect.

An eighth aspect of the present invention provides a method of configuring a controlled atmosphere container to perform an air leak test, the controlled atmosphere container comprising: a cargo space for storing cargo; a filter (such as a membrane) configured to permit fluid flow to adjust a composition of the atmosphere in the cargo space, the filter opening into the cargo space and a pump coupled to the filter and operable to cause the atmosphere in the cargo space to move through the filter and into an external atmosphere outside of the cargo space; wherein the method comprises coupling a valve to the pump, in a parallel fluid arrangement with the filter, wherein the valve is configurable to open into the space.

In this way, the valve may be openable to permit the atmosphere to move from the cargo space to the external atmosphere via the valve and the pump. This may permit an increased flow rate of the atmosphere from the cargo space to the external atmosphere, which may otherwise be restricted by the filter. This may allow a more accurate air leak test to be performed.

Optionally, the method of the eighth aspect comprises connecting the valve and the pump to a controlled atmosphere container controller configured to perform the air leak test. Optionally, the method of the eighth aspect comprises providing and/or installing the controlled atmosphere container controller in the controlled atmosphere container. Optionally, the method of the eighth aspect comprises configuring an existing controller of the controlled atmosphere container to perform the air leak test. This may comprise configuring a processor of the existing controller to execute instructions that cause the processor to perform the method of the fourth aspect. Optionally, the method of the eighth aspect comprises installing the non-transitory computer-readable storage medium of the fifth aspect in the controlled atmosphere container, such as by connecting the processor of the existing controller to the non-transitory computer-readable storage medium of the fifth aspect.

Optionally, the controlled atmosphere container controller is the controlled atmosphere container controller of the first aspect. Optionally, the controlled atmosphere container is the controlled atmosphere container of the second aspect. Optionally, the valve and the controlled atmosphere container controller are a part of the kit of parts of the third aspect. Optionally, the method of the eighth aspect comprises performing the method of the fourth aspect to perform the air leak test.

It will be understood that the method of the eighth aspect may benefit from any of the optional features and/or advantages of any of the first to sixth aspects.

More generally, it will be appreciated that features of any one of the above aspects may be combined with features of any other of the above aspects. Similarly, any of the optional features for one aspect may be combined with those of another aspect.

### BRIEF DESCRIPTION OF DRAWINGS

Embodiments of the invention will now be described, by way of example only, with reference to the accompanying drawings, in which:

FIG. 1 is a schematic diagram showing a controlled atmosphere container comprising a controlled atmosphere container controller according to an example;

FIG. 2 is a graph showing a change in pressure in the controlled atmosphere container of FIG. 1 during an air leak test, according to an example;

FIG. 3 shows a marine vessel comprising the controlled atmosphere container of FIG. 1, according to an example;

FIG. 4 shows a method of performing an air leak test in the controlled atmosphere container of FIG. 1, according to an example;

FIG. 5 shows a kit of parts for performing a test for an air leak in the controlled atmosphere container of FIG. 1, according to an example;

FIG. 6 shows a non-transitory computer-readable storage medium, according to an example; and

FIG. 7 shows a method of configuring a controlled atmosphere container to perform an air leak test, according to an example.

### DETAILED DESCRIPTION

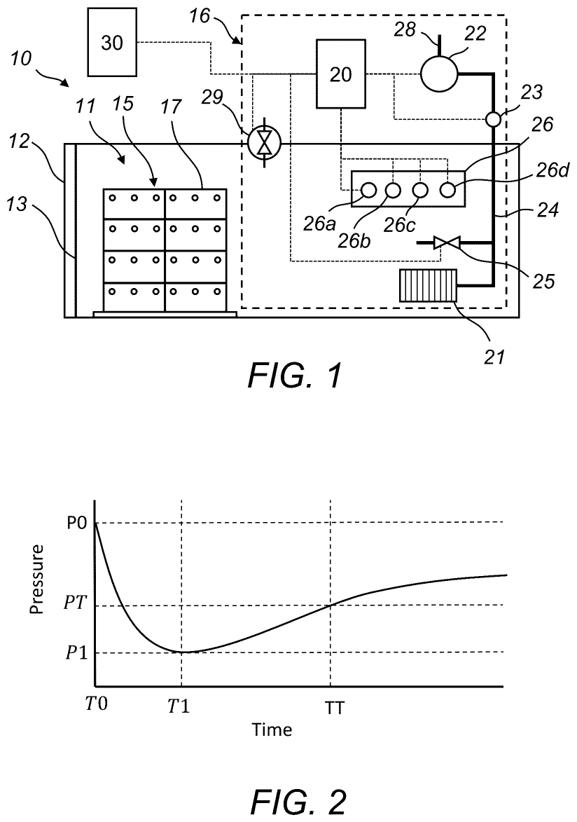

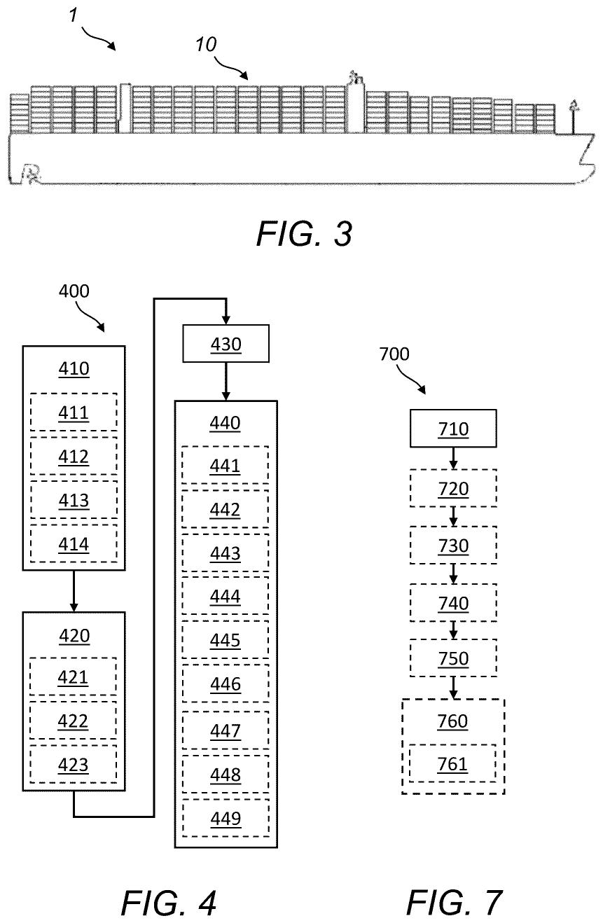

FIG. 1 shows an example of a controlled atmosphere container 10 comprising a controlled atmosphere container controller 20 (herein the “controller 20”). The controlled atmosphere container 10 comprises a cargo space 11 and a door 12 into the cargo space. The cargo space is configured to store cargo 15 in use. The controlled atmosphere container 10 is, in this example, a transport unit for transporting the cargo 15, such as on a marine vessel 1 as shown in FIG. 3. The marine vessel 1 is a container ship, but may be any other suitable vessel. Alternatively, the controlled atmosphere container 10 may be any other suitable container, such as a storage unit for storing the cargo 15 in a warehouse.

The cargo 15 in this example comprises produce, and in particular ripenable produce. Alternatively, the cargo 15 could comprise other fresh or frozen produce, medicaments, or any other suitable cargo 15. The ripenable produce is stored in palletised crates 17, which are ventilated to the atmosphere in the cargo space 11. In this way, the atmosphere may be controlled to control a ripening process of the cargo 15, as described in more detail below.

The controlled atmosphere container 10 comprises a curtain 13 for sealing, or mostly scaling, the door 12 when closed. This may prevent or limit an atmosphere leaking into and/or out of the cargo space 11 through the door 12, such as through gaps in door 12 when closed, in use. The controlled atmosphere container 10 is otherwise sealed to an external atmosphere outside the cargo space 11. However, the controlled atmosphere container 10 may not be completely air-tight. That is, an atmosphere may still leak into and/or out of the cargo space, such as through gaps in the container 10, such as gaps surrounding valves, conduits, or other components opening into the cargo space and/or passing through walls of the container 10 enclosing the cargo space.

The controlled atmosphere container 10 of the present example comprises an atmosphere control system 16 for controlling an atmosphere in the cargo space 11. The atmosphere control system 16, or at least a part thereof, is operable by the controlled atmosphere container controller 20.

The atmosphere control system 16 is operable to control a composition of the atmosphere in the cargo space 11, such as a level of O2 and/or CO2 in the cargo space. In particular, the atmosphere control system 16 comprises a membrane 21 in the cargo space 11. The membrane 21 is fluidically connected, or connectable, to a pump 22, specifically by a conduit 24 in this example. The pump is configurable to open into an external atmosphere outside of the cargo space 11 via a pump outlet 28. The pump 22 here is a vacuum pump, but may in other examples be any other suitable pump. The pump 22 is operable to move the atmosphere from the cargo space 11 to the external atmosphere through the membrane 21 and the pump outlet 28. The pump 22 may be a positive displacement pump, or any other suitable pump 22. The membrane 21 is configured to permit carbon dioxide (CO2) from the atmosphere to pass therethrough, but to prevent, or limit, oxygen (O2) and/or nitrogen (N2) from the atmosphere from passing therethrough. In this way, the membrane 21 is configured to filter CO2 from the atmosphere. The CO2 filtered using the membrane 21 is then passed to the external atmosphere via the pump 22. Most, or all, of the O2 and N2 from the atmosphere passing through the membrane 21 remains in the cargo space 11.

The ripenable produce 15, as it ripens in a ripening process, converts O2 from the atmosphere in the cargo space 11 into CO2. As such, a level of CO2 in the cargo space 11, which is sealed, or mostly sealed, to the external atmosphere in use, may increase over time. An increase in CO2 may subsequently increase a rate of ripening of the ripenable produce 15. Therefore, the atmosphere in the cargo space 11 may be caused to move through the membrane 21 to extract CO2 from the atmosphere in order to control, such as limit, the rate of ripening. This may allow the ripenable produce to be stored for longer periods of time, such as to allow the produce to be shipped over longer distances, while arriving at its destination at a desired level of ripeness.

In order to monitor the levels of O2, CO2 and/or N2 in the cargo space 11, the atmosphere control system 16 comprises a sensor system 26 for sensing one or more characteristics of the atmosphere in the cargo space 11. The sensor system 26 in this example comprises an O2 sensor 26a and a CO2 sensor 26b for respectively sensing a level of O2 and a level of CO2 in the atmosphere in the cargo space 11. That is, the O2 sensor and CO2 sensor are each configured to sense a composition of the atmosphere in the cargo space 11. The sensor system also comprises a pressure sensor 26c for sensing a pressure of the atmosphere in the cargo space 11, and a temperature sensor 26d for sensing a temperature of the atmosphere in the cargo space 11. Each of the sensors 26a-26d in the sensor system 26, and/or the sensor system 26 as a whole, is communicatively coupled to the controlled atmosphere container controller 20. In this way, the sensors 26a-26d and/or the sensor system 26 are configured to send signals indicative of characteristics of the atmosphere, such as composition, pressure, and/or temperature of the atmosphere in the cargo space 11 to the controller 20. The controller 20 is configured to receive the signals from the sensors 26a-26d and/or the sensor system 26. It will be understood from the following disclosure that, in various examples, any one or more of the sensors 26a-26d in the sensor system 26 may be omitted or may not be a part of the sensor system 26. The sensors 26a-26d are here located in the cargo space 11. In other examples, one or more or the sensors 26a-26d are located elsewhere, such as outside the cargo space 11, while being in a suitable location so as to sense the respective characteristics in the cargo space 11.

The atmosphere control system 16 also comprises a conduit pressure sensor 23 configured to sense a pressure in the conduit 24 fluidically connecting the membrane 21 and the pump 22. The conduit pressure sensor 23 is communicatively coupled to the controller 20 and is configured to send signals representative of a pressure in the conduit 23 to the controller 20. That is, the conduit pressure sensor 23 is configured to sense a differential pressure created by the pump 22 during operation of the pump. The conduit pressure sensor 23 may alternatively be a part of the sensor system 26, and/or may be communicatively coupled to the sensor system 26.

The atmosphere control system 16 also comprises a fresh air valve 29, which is configurable to fluidically couple the atmosphere in the cargo space 11 to the external atmosphere outside of the cargo space 11. Specifically, in this example, the fresh air valve 29 may be opened and closed to selectively permit the external atmosphere to flow into the cargo space 11. This may allow a level of O2 and/or N2 in the atmosphere in the cargo space 11 to be controlled, such as during ripening of the ripenable produce 15. In particular, as noted above, a level of O2 in the atmosphere in the cargo space 12 may be reduced, and specifically converted into CO2, as the ripenable produce 15 respires during the ripening process. As such, while the membrane 21 is configured to remove CO2 from the atmosphere in the cargo space, the fresh air valve 29 is configured to permit the external atmosphere, which may comprise O2-rich external air, into the cargo space 11 to increase a level of O2 in the atmosphere in the cargo space 11. The external atmosphere may flow into the cargo space due to a vacuum caused to be present in the cargo space 11, such as by the vacuum pump 22 extracting the atmosphere in the cargo space 11 through the membrane 21, and/or by any other means as described herein.

The fresh air valve 29 is communicatively coupled to the controller 20. The controller 20 is configured to cause the fresh air valve to open and close to control the level of O2 of the atmosphere in the cargo space 11. More broadly, the controller 20 is configured to control a composition of the atmosphere in the cargo space. This is, for instance, by the controller causing the atmosphere in the cargo space 11 to be moved from the cargo space 11, such as via the membrane 21, such as by causing operation of the pump 22. This may also be, for instance, by the controller causing an external atmosphere to move into the cargo space 11, such as by operating the fresh air valve 29.

In some examples, though not shown here, the atmosphere control system 16 is configured to be operable in a cooling mode to reduce a temperature of the atmosphere in the cargo space 11, and/or in a heating mode to increase a temperature of the atmosphere in the cargo space 11. In other words, the atmosphere control system 16 may be configured to control a temperature of the cargo 15 in the cargo space 11. It will be appreciated that the atmosphere control system 16 may comprise any suitable components for cooling and/or heating the atmosphere in the cargo space, such as a heat exchanger, which is optionally coupled in a refrigeration cycle. The atmosphere control system 16 may also comprise a fluid moving device for moving the atmosphere in the cargo space 11, such as for moving the atmosphere through, or across, the heat exchanger. By being operable in the cooling mode to cool the atmosphere in the cargo space 11, the atmosphere control system 16 may be able to control the ripening process of the ripenable produce 15. In particular, a low temperature may inhibit ripening, or reduce a ripening rate, of the produce 15. Moreover, heat is emitted from the produce 15 during the ripening process, which may be extracted from the cargo space 11 by the atmosphere control system to control further ripening.

The controller 20 may be configured to cause the atmosphere control system 16 to operate in the cooling and/or heating modes. The temperature sensor 26c, and/or any other suitable temperature sensor(s) in the atmosphere control system 16 and/or the controlled atmosphere container 10, may be used to permit a closed-loop control of the temperature of the atmosphere in the cargo space 11. Alternatively, the atmosphere control system 16 may comprise a further controller (not shown) for causing the atmosphere control system 16 to operate in the cooling and/or heating modes. Alternatively, the atmosphere control system 16 may be caused to operate as such by a remote controller 30, remote from the controlled atmosphere container 10, which will be described in more detail below. The further controller and/or the remote controller 30 may be communicatively coupled to the controller 20, so as to permit a transfer of information relating to a state of the atmosphere in the cargo space 11, and or relating to an integrity of the controlled atmosphere container 10, between different systems. In other examples, the atmosphere control system 16 is not configured to control a temperature in the cargo space 11. In some such examples, the controlled atmosphere container 10 comprises a further atmosphere control system for controlling the temperature in the cargo space 11.

Finally, in the present example, the controlled atmosphere container 10, and particularly the atmosphere control system 16, comprises a valve 25 which is configurable to open into the cargo space 11. The valve 25 is fluidically connected, or connectable, to the pump 22 in parallel with the membrane 21. This is by the valve 25 being connected to the conduit 24 fluidically connecting the membrane 21 and the pump 22. In other examples, the valve 25 may be connected in any other suitable location, such as at one end of the membrane 21. In any event, the valve 25 is operable so that the atmosphere in the cargo space 25 can be extracted from the cargo space 25 via the pump. The atmosphere can flow through the valve 25 at a higher flow rate than through the membrane 21, which is restricted due to the filtering effect of the membrane 21. The valve 25 may therefore allow the vacuum pump 22 to create a greater pressure difference between the atmosphere in the cargo space 11 and the external atmosphere than would otherwise be possible using the membrane 21 alone. In other examples, the pump 22 may be operable to pass external air into the cargo space 11 via the valve 25, such as to increase the pressure in the cargo space 11 relative to the external atmosphere outside the cargo space 11.

It will be understood that, in other examples, any one or more of the components introduced above, such as the valve 25, the fresh air valve 29, the sensor system 26, the pump 22 and/or the membrane 21 may not be a part of the atmosphere control system 16 but may instead be comprised in another system that is connected to, or is a part of, the controlled atmosphere container 10.

As noted above, in some examples, the controlled atmosphere container 10 may not be completely air-tight. As such, in the event of a pressure difference between the atmosphere in the cargo space 11 and the external atmosphere outside of the cargo space, the external atmosphere may leak into the cargo space 11, or the atmosphere in the cargo space 11 may leak out of the cargo space 11. Some leakage may be acceptable, but increased leakage may reduce an ability of the atmosphere control system 16 to control the atmosphere in the cargo space 11, which may, in turn, lead to undesired and/or premature ripening of the produce.

The controlled atmosphere container controller 20 of the present example is therefore configured to perform a test for an air leak (herein an “air leak test”) in the controlled atmosphere container 10. The air leak test will be described in more detail below, but in general comprises the controller 20 causing a pressure difference between the atmosphere in the cargo space 11 and the external atmosphere outside of the cargo space, such as by causing the pump 22 to operate and causing the valve 25 open. Alternatively, or in addition, the controller 20 may cause the pressure difference by causing a reduction in temperature of the atmosphere in the cargo space 11, so as to cause a corresponding reduction in pressure in the cargo space 11. The controller 20 then stops causing the pressure difference, such as by causing the pump 22 to stop operating, closing the valve 25, and/or stopping cooling of the atmosphere in the cargo space 11. The controller 20 then monitors the pressure of the atmosphere in the cargo space 11 over time, which will increase due to the external atmosphere leaking into the cargo space 15. The greater the leakage, the faster the increase in pressure.

This process is shown in more detail in FIG. 2. Here, the pressure of the atmosphere in the cargo space 11 (shown on the y-axis) is caused to reduce from an initial pressure P0 at a zeroth time T0 (time on the x-axis) to a reduced pressure P1 at a first time T1. P0 may correspond to a pressure in the cargo space when the doors 12 are open, which may be the same as an ambient pressure of the external atmosphere. Alternatively, P0 may be a pressure in the container 10 when the container 10 is in use, such as when the atmosphere control system 16 is operated in the cooling mode. P1 is lower than P0 in the example shown, indicating a reduction in pressure, such as caused by operating the vacuum pump 22 and optionally opening the valve 25, and/or by reducing a temperature of the atmosphere in the cargo space 11 as described above. At time T1, the controller 20 stops causing the reduction in pressure in the cargo space 11, and the pressure is allowed to “equalise”. That is, the pressure is allowed to increase towards an “equalised” pressure. When the pressure is equalised as such, the container 10 may be said to be in an equalised state. The equalised pressure may be the pressure P0. Alternatively, the equalised pressure may be another pressure, such as a pressure of the external atmosphere. This may particularly be the case if a mode of operation of the atmosphere control system 16 is changed after the time T0, such as before, at, or after the time T1. In any event, the pressure changes towards such an equalised pressure due to the external atmosphere leaking into the cargo space 11. The pressure increase may be logarithmic, and so may take a long time to reach the equalised pressure. As such, the controller 20 in the present example is configured to compare the pressure following the stopping to a threshold pressure PT, which is reached at a time TT following the stopping. The controller 20 is further configured to determine that the container 10 comprises an air leak. As discussed in more detail below, an air leak may be identified, for instance, when the time TT for the pressure to reach the threshold pressure is below a threshold time. This would indicate that external air is leaking into the container, and thereby increasing the pressure, at a faster rate than is considered acceptable.

In some examples, the time T1 is up to 5 minutes, up to 10 minutes, up to 15 minutes, or greater than 15 minutes from T0. In some examples, the vacuum pump 22, when operated to extract the atmosphere through the membrane 21 alone, is able to generate a differential pressure, such as sensed by the conduit pressure sensor 23, of up to 20 mbar, up to 40 mbar, up to 60 mbar, up to 80 mbar, or more than 80 mbar. In some examples, the vacuum pump 22, when operated to extract the atmosphere through the valve 25 alone, or in combination with the membrane 21, is able to generate a differential pressure, such as sensed by the conduit pressure sensor 23, that is greater than that when the vacuum pump 22 is operated to extract the atmosphere through the membrane 21 alone. For instance, when the pump is operated to extract the atmosphere through the valve 25, a differential pressure, as detectable by the pressure sensor, may be up to 200 mbar, up to 300 mbar, up to 400 mbar, up to 500 mbar, up to 600 mbar, or greater than 600 mbar. In this way, a pressure differential between the atmosphere in the cargo space 11 and the external atmosphere may be generated more quickly, and/or a greater differential pressure may be generated, by extracting the atmosphere through the valve 25. For example, the atmosphere control system 16 may be operable, such as by operating the pump 22 and opening the valve 25, to create a pressure difference between the atmosphere in the cargo space 11 and the external atmosphere of up to 2 mbar, up to 4 mbar, up to 8 mbar, or greater than 8 mbar. The time taken to generate such a pressure difference may be up to 5 minutes, up to 8 minutes, up to 10 minutes, up to 15 minutes, or greater than 15 minutes, for example.

Turning now to FIG. 4, the method 400 of performing the air leak test is described more generally. The dashed boxes represent optional features of the method 400. The method 400 comprises the controller 20 causing 410 a first characteristic of the atmosphere in the cargo space 11 to have a first value. In this case, the first characteristic is pressure, and it is caused by the controller 20 to have the value P1 shown in FIG. 2. In the illustrated example, this is by the controller 20 causing 411 the valve 25 to open and/or causing 412 the pump to operate. It will be appreciated that the controller 20 in the present example is further configured to cause the fresh air valve 29 to close and/or remain closed during the air leak test, so as to attempt to maintain the container 10, and particularly the cargo space 11, in a sealed state. That is, the method 400 may comprise the controller 20 causing 413 the fresh are valve 29 to close, and/or remain closed.

In other examples, the causing 410 the first characteristic to have the first value comprises the controller 20 causing 414 the atmosphere control system 16 to operate in the cooling mode or the heating mode. It will be appreciated that, in other examples, the first characteristic may be any other suitable characteristic, such as a temperature and/or composition of the atmosphere in the cargo space 11. That is, the method 400 may comprise the controller 20 causing 410 a temperature of the atmosphere to have the first value, such as to cause a corresponding reduction in pressure in the cargo space 11.

The method 400 then comprises the controller 20 stopping 420 the causing the first characteristic to have the first value, such as in any one of the ways described above. For instance, the method 400 may comprise the controller 20 causing 421 the valve 25 to close and/or causing 422 the pump 22 to stop operating. Alternatively, or in addition, the method 400 may comprise the controller 20 causing 423 the atmosphere control system 16 to stop operating in the cooling or heating mode.

The method 400 then comprises the controller 20 receiving 430, in a time period following the stopping 420, a signal from one or more of the sensors 26a-26d in the sensor system 26. The signal is representative of a value of a second characteristic of the atmosphere in the cargo space 11 during the time period. Referring again to FIG. 2, in the present example, the controller 20 receives a signal from the pressure sensor 26c, the signal being representative of the pressure of the atmosphere in the cargo space 11. In other words, in this example, the second characteristic is pressure. That is, the second characteristic comprises the first characteristic, and indeed the second characteristic is the first characteristic. Alternatively, the second characteristic may be, or may comprise, any other suitable characteristic, such as a temperature and/or composition of the atmosphere in the cargo space 11. That is, the controller 20 may receive 430 the signal from one or more of: the temperature sensor 26d; the O2 sensor 26a; and/or the CO2 sensor 26b. For instance, an increase in a level of O2 in the atmosphere may be caused by the external atmosphere, which may be oxygen-rich, leaking into the cargo space 11. As such, the controller 20 may cause 410 a reduction in pressure of the atmosphere to the first value, and then receive and/or monitor signals representative of a level of O2 in the atmosphere following the stopping 420.

Finally, the method 400 comprises the controller 20 performing 440 an action to permit determination of an air leak in the controlled atmosphere container 10, on the basis of the signal received. As noted above, the controller 20 performing 440 the action, in the present example, comprises the controller 20 comparing 441 the value of the second characteristic in the time period following the stopping 420, which in this case is pressure, to a threshold pressure PT. More broadly, the method comprises the controller 20 comparing 441 the value of the second characteristic to a threshold second characteristic. As such, if the second characteristic is a temperature and/or composition of the atmosphere, the threshold second characteristic may be a threshold temperature and/or a threshold composition.

The threshold second characteristic comprises a value of the second characteristic that would be reached after a given time following the stopping for a container 10 having an acceptable air leak. If, for instance, the pressure exceeds the threshold pressure PT at the time TT, then the container may have an unacceptable air leak. This may similarly be the case if the pressure reaches the threshold pressure PT at a time that is less than a threshold time as discussed above. The performing 440 the action may therefore comprise determining 442 a time taken, following the stopping, for the second characteristic to meet, exceed, or reduce below (such as when the pressure is caused 410 to increase in the cargo space 11 during the test), the threshold second characteristic. The performing 440 the action may then comprise the controller 20 comparing 443 the time taken to the threshold time.

The threshold second characteristic and/or the threshold time may be predetermined, and/or may be determined by the controller 20 prior to or during the test. For example, the controller 20 may be configured determine the threshold second characteristic based on one or more of: a pressure difference between the atmosphere and the external atmosphere when the controller stops 420 the causing the second characteristic to have the first value; a temperature of the atmosphere in the cargo space 11; a temperature of the external atmosphere outside the cargo space 11; a composition of the atmosphere in the cargo space 11; a mode of operation of the atmosphere control system 16 during the test; and whether there has been a change in the mode of operation of the atmosphere control system 16 during the test. For instance, if the pressure difference at the time of the stopping 420 is relatively large, then a leakage of the external atmosphere into the cargo space 11 may be expected to be correspondingly large. In such a case, the threshold pressure (and/or the threshold time) may be larger than when there is a relatively lower pressure difference at the time of the stopping 420. Similarly, in some examples, the atmosphere control system 16 may be operated in a cooling mode at or before the time of the stopping 420, and may be caused to stop operating, or to operate in the heating mode, in the time period following the stopping 420. In such a case, the temperature and/or pressure on the atmosphere may increase more quickly in the time period following the stopping than if the controlled atmosphere container were to continue to be operated in the cooling mode during the test, or than if it were never operated during the test.

The determined and/or predetermined threshold second characteristic may be between the first value and an equalised characteristic. The equalised characteristic may be a value that the second characteristic might be expected to take when the container is in the equalised state described above. For example, the equalised characteristic might be the equalised pressure described above. In other examples, the equalised characteristic may be a value that the first characteristic assumed before, or at the start of, the air leak test. In some examples, the threshold second characteristic is distanced from the first characteristic or distanced from the equalised characteristic by an amount that is less than or greater than one-third, or less than or greater than one-quarter of the difference between the first characteristic and the equalised characteristic. In this way, a potential air leak in the controlled atmosphere container may be detected or determined when the value of the second characteristic during the time period following the stopping exceeds, reduces below, and/or is within a tolerance of, the threshold second characteristic.

In some examples, the performing 440 the action comprises the controller 20 comparing 444 the value of the second characteristic to the equalised characteristic. In some examples, the performing 440 the action comprises the controller comparing 445 the value of the second characteristic in the time period following the stopping 420 to the first value. That is, the action may comprise determining to what extent the value of the second characteristic has departed from the first value in the time period following the stopping. In the event of an air leak, the second characteristic may depart from the first characteristic more quickly following the stopping.

In some examples, the performing 440 the action comprises the controller 20 determining 446 that there is, or may be, an air leak in the controlled atmosphere container 10. This is, for example, by the controller 20 determining that: the value of the second characteristic has met, exceeded, or reduced below the threshold second characteristic; or the time taken for the second characteristic to meet, exceed, or reduce below the threshold second characteristic has met, or reduced below the threshold time. In some examples, the determining 446 that there is, or may be, an air leak in the controlled atmosphere container 10 comprises determining a rate of leakage of the external atmosphere into the cargo space 11, and/or determining a rate of leakage of the atmosphere in the cargo space 11 out of the cargo space 11. In some examples, the determining 446 that there is, or may be, an air leak in the controlled atmosphere container 10 comprises determining that the rate of leakage exceeds a rate of leakage threshold.

In some examples, the performing 440 the action comprises the controller 20 transmitting 447 any one of the values or determined qualities described above, such as any one or more of: the first value; the value of the second characteristic during the time period; the time taken for the second characteristic to meet, exceed, or reduce below the threshold second characteristic; and the result of the determination that there is, or may be, a leak in the controlled atmosphere container 10. The transmitting may be, for example, to a user device (not shown) and/or to another controller, such as another controller of the atmosphere control system 16, another controller of the controlled atmosphere container 10, and/or the remote controller 30. In some examples, the transmitting 447 comprises issuing an alarm, or an alert, such as to notify a user that an air leak has been determined.

In some examples, the performing 440 the action comprises saving 448 any one of these values or determined qualities to memory, such as instead of, or before or after the transmitting the value(s). The memory may be a memory of the controller 20, another memory of the controlled atmosphere container, and/or a remote memory, such as a memory of the remote controller 30. In some examples, the performing 440 the action comprises the controller 20 displaying 449 any of these values, such as on a display of the controlled atmosphere container 10, a display of a user device (not shown) or a display of a remote system, such as a remote system comprising the remote controller 30.

It will be understood that the controller 20 is configured to perform the air leak test when the doors 12 are closed, and the seal 13 is installed. More specifically, the controller 20 is configured to perform the air leak test when the controlled atmosphere container 10 is operating to control the atmosphere in the cargo space, such as using the atmosphere control system 16. This may be when the controlled atmosphere container is in transit. As such, the controller 20 can advantageously perform the air leak test “on-the-fly” and may not require the controlled atmosphere container to be taken out of operation.

The controller 20 is configured to perform the test on receipt by the controller 20 of an initiation signal. The initiation signal may be received from a control panel of the container 10, from a remote system, such as the remote controller 30, and/or from another system of the controlled atmosphere container 10. The initiation signal may be issued manually, by a user, or automatically, such as in response to a condition of the atmosphere in the cargo space meeting one or more criteria. Alternatively, the controller 20 may be configured to monitor the condition of the atmosphere in the cargo space 11, and to perform the test in response to the condition reaching the one or more criteria, such as without receiving an initiation signal.

The one or more criteria may comprise a level of O2 in the atmosphere reducing, such as by up to 1%, up to 2%, up to 5%, or more than 5% of an initial level of O2 in the atmosphere, such as before or shortly after the doors are closed. Alternatively, or in addition, the one or more criteria may comprise a level of CO2 in the atmosphere increasing, such as by up to 1%, up to 2%, up to 5%, or more than 5% of an initial level of O2 in the atmosphere. This may indicate that the produce 15 has started respiring. This may imply that the container 10 is closed and there is respiring cargo 15 inside, which may be a suitable time to perform the test. Alternatively, or in addition, this may imply that a ripening process has started prematurely, indicating a potential air leak. In some examples, the one or more criteria comprise an indication that the atmosphere control system 16 is being operated in a cooling mode and/or a heating mode. In some examples, the one or more criteria comprise a temperature and/or pressure in the cargo space changing. In other examples, the one or more criteria comprise an efficiency and/or cooling capacity of the atmosphere control system reducing below a respective efficiency and/or cooling capacity threshold, which may indicate a potential leak. It will be understood that the one or more criteria may comprise any other suitable criteria which indicate, for example, that the door 12 is closed, that the controlled atmosphere container 10 comprises produce, such as respiring produce, in the cargo space 11, and/or that there is a suspected air leak.

In some examples, a leak may be present when the curtain 13 is not fitted properly, such as when there is a gap between the curtain and a wall and/or door of the container 10. In various examples, the controlled atmosphere container comprises a drain (not shown), such as located in the cargo space 11, which can be opened to allow liquid to drain from the container 10, such as water that has condensed in the cargo space 11, in use. In some such examples, a leak may be present when the drain has not been plugged after use. In other examples, a leak may be present due to a defect in any other part of the container separating the atmosphere in the cargo space 11 from the external atmosphere outside of the cargo space 11.

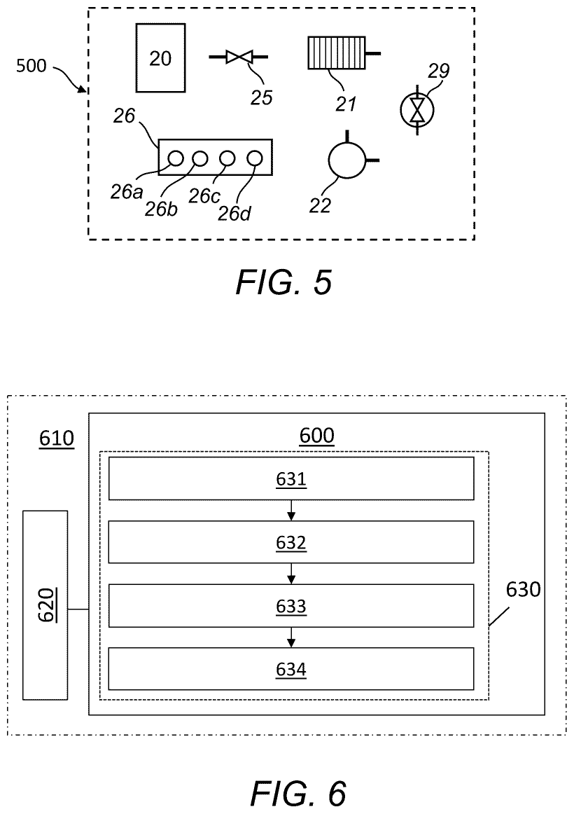

FIG. 5 shows a kit of parts 500 for performing the test for an air leak in the controlled atmosphere container 10. The kit of parts 500 comprises the controlled atmosphere container controller 20 and the valve 25. This kit of parts 500 can be used, for example, to modify an existing controlled atmosphere container 10 to allow the air leak test to be performed. This may be used in situations where the container 10 does not comprise the valve 25 and/or the controller 20 that is configured to perform the air leak test. In other examples, instead of, or in addition to, the controller 20, the kit of parts may comprise a non-transitory computer-readable storage medium storing instructions that, when executed by a processor, cause the processor to perform the method of FIG. 4. In this way, a processor of an existing controller of the controlled atmosphere container 10 may be configurable to execute the instructions stored on the non-transitory computer-readable storage medium. The non-transitory computer-readable storage medium may be the non-transitory computer-readable storage medium 700 described below with reference to FIG. 6.

In some examples, as shown in FIG. 5, the kit of parts 500 may comprise other components of the atmosphere control system 16 shown in FIG. 1, such as the membrane 21, the pump 22, the fresh air valve 29, the sensors 26a-26d and/or the sensor system 26. These components may be provided where such components are absent from an existing controlled atmosphere container 10 that is to be reconfigured to perform the air leak test. Alternatively, the kit of parts 500 can be provided to be installed in a new controlled atmosphere container 10 during manufacture of the controlled atmosphere container 10.

FIG. 6 shows a schematic diagram of a non-transitory computer-readable storage medium 600 according to an example. The non-transitory computer-readable storage medium 600 stores instructions 630 that, if executed by a processor 620 of a controller 610, cause the processor 620 to perform a method according to an example. In some examples, the controller 610 is the controlled atmosphere container controller 20 described above or any variation thereof discussed herein. The instructions 630 comprise: causing 631 the first characteristic of the atmosphere in the cargo space 11 to have the first value; stopping 632 the causing the first characteristic to have the first value; receiving 633, in the time period following the stopping, the signal from the sensor 26c configured to sense the second characteristic of the atmosphere in the cargo space 11, the signal representative of the second characteristic of the atmosphere in the cargo space 11 during the time period; and performing 634 the action to permit determination of an air leak in the controlled atmosphere container, on the basis of the signal. In other examples, the instructions 630 comprise instructions to perform any other example method described herein, such as the method 400 described above with reference to FIG. 4. In some examples, the controlled atmosphere container 10, the atmosphere control system 16, the controller 20, the remote controller 30, and/or any other suitable controller comprises the non-transitory computer-readable storage medium 600.

FIG. 7 shows an example method 700 of configuring the controlled atmosphere container 10 to perform the air leak test. This method 500 is for use when the controlled atmosphere container 10 comprises the membrane 21 and the pump 22, but does not comprise, for example, the valve 25 or the controller 20, or where the controller 20 is not suitably configured to perform the air leak test. The method comprises coupling 710 the valve 25 to the pump 22 in parallel to the membrane 21. That is, the method can be used to retrofit an existing container 10 with the valve 25, to permit the pump 22 to reduce the pressure in the cargo space 11 to a greater extent than through the membrane 21, thereby allowing the container to perform the air leak test, and/or to improve an accuracy of the air leak test.

In some examples, the method 700 comprises connecting 720 the valve and/or the pump to the controlled atmosphere container controller 20. In some examples, the method 700 comprises providing 730 and/or installing 740 the controlled atmosphere container controller 20 in the controlled atmosphere container 10, such as by providing the kit of parts 500. Optionally, the method 700 comprises configuring an existing controller of the controlled atmosphere container 10 to perform the air leak test, such as where the controller 20 is already installed in the controlled atmosphere container 10. This may comprise configuring 750 a processor of the existing controller 20 to execute instructions that cause the processor to perform the test, such as by the method 400 of performing the test shown in FIG. 4. In some such examples, the method 700 comprises installing 760 the non-transitory computer-readable storage medium 600 described above in the controlled atmosphere container 10, which may comprise connecting 761 the processor of the existing controller 20 to the non-transitory computer-readable storage medium 600.

Example embodiments of the present invention have been discussed, with particular reference to the examples illustrated. However, it will be appreciated that variations and modifications may be made without departing from the scope of the invention as defined by the appended claims.

What is claimed is:

1. A controlled atmosphere container controller for a controlled atmosphere container, the controlled atmosphere container comprising a cargo space for storing cargo, the controlled atmosphere container controller configured to perform a test for an air leak in the controlled atmosphere container, the test comprising the controlled atmosphere container controller:
causing a first characteristic of an atmosphere in the cargo space to have a first value;
stopping causing the first characteristic to have the first value;
receiving, in a time period following the stopping, a signal from a sensor configured to sense a second characteristic of the atmosphere in the cargo space, the signal representative of a value of the second characteristic of the atmosphere in the cargo space during the time period; and
performing an action to permit determination of an air leak in the controlled atmosphere container, on the basis of the signal.

2. The controlled atmosphere container controller of claim 1, comprising a filter configured to permit fluid flow therethrough to adjust a composition of the atmosphere in the cargo space.

3. The controlled atmosphere container controller of claim 2, wherein the filter is a membrane.

4. The controlled atmosphere container controller of claim 2, comprising a valve configurable to open into the cargo space.

5. The controlled atmosphere container controller of claim 4, comprising a pump arranged to fluidically couple both the filter and the valve to an external atmosphere outside the cargo space, wherein the valve is fluidically connected, or connectable, to the pump in parallel with the filter.

6. The controlled atmosphere container controller of claim 5, wherein the controlled atmosphere container controller causing the first characteristic of the atmosphere in the cargo space to have the first value comprises the controlled atmosphere container controller causing the valve to open into the cargo space and/or causing the pump to operate.

7. The controlled atmosphere container controller of claim 6, wherein the controlled atmosphere container controller stopping causing the first characteristic to have the first value comprises the controlled atmosphere container controller causing the valve to close and/or causing the pump to stop operating.

8. The controlled atmosphere container controller of claim 1, wherein the first characteristic comprises a pressure, a temperature, and/or a composition of the atmosphere in the cargo space.

9. The controlled atmosphere container controller of claim 1, wherein the second characteristic comprises the first characteristic.

10. The controlled atmosphere container controller of claim 9, wherein the controlled atmosphere container controller performing the action comprises the controlled atmosphere container controller comparing the value of the second characteristic during the time period to the first value.

11. The controlled atmosphere container controller of claim 1, wherein the test comprises the controlled atmosphere container controller receiving, during the test, a further signal from the sensor or a further sensor, the further signal representative of a further value of the second characteristic during the test; and
the performing the action comprises comparing the value of the second characteristic during the time period to the further value of the second characteristic during the test.

12. A controlled atmosphere container comprising the controlled atmosphere container controller of claim 1 and the cargo space for storing cargo.

13. The controlled atmosphere container of claim 12, comprising
a filter configured to permit fluid flow therethrough to adjust a composition of the atmosphere in the cargo space;
a valve configurable to open into the cargo space; and
a pump arranged to fluidically couple both the filter and the valve to an external atmosphere outside the cargo space, wherein the valve is fluidically connected, or connectable, to the pump in parallel with the filter.

14. A kit of parts for performing a test for an air leak in a controlled atmosphere container, the kit of parts comprising:
the controlled atmosphere container controller of claim 1, wherein the controlled atmosphere container comprises the cargo space for storing cargo; and
a valve configurable to selectively fluidically couple the cargo space with an external atmosphere outside the cargo space.

15. A method of performing a test for an air leak in a controlled atmosphere container, the controlled atmosphere container comprising a controller and a cargo space for storing cargo, the method comprising the controller:
causing a first characteristic of an atmosphere in the cargo space to have a first value;
stopping causing the first characteristic to have the first value;
receiving, in a time period following the stopping, a signal from a sensor configured to sense a second characteristic of the atmosphere in the cargo space, the signal representative of a value of the second characteristic of the atmosphere in the cargo space during the time period; and
performing an action to permit determination of an air leak in the controlled atmosphere container, on the basis of the signal.

16. The method of claim 15, wherein the controlled atmosphere container comprises:
a filter configured to permit fluid flow therethrough to adjust a composition of the atmosphere in the cargo space;
a valve configurable to open into the space; and
a pump arranged to fluidically couple both the filter and the valve to an external atmosphere outside the cargo space, wherein the valve is fluidically connected, or connectable, to the pump in parallel with the filter.

17. The method of claim 16, wherein the filter is a membrane.

18. The method of claim 16, wherein the controller causing the first characteristic of the atmosphere in the cargo space to have the first value comprises the controller causing the valve to open and/or causing the pump to operate; and
wherein the controller stopping causing the first characteristic to have the first value comprises the controller causing the valve to close and/or causing the pump to stop operating.

19. A non-transitory computer-readable storage medium storing instructions that, when executed by a processor of a controlled atmosphere container controller, cause the processor to carry out the method according to claim 15.

20. A marine vessel comprising the controlled atmosphere container controller of claim 1, the controlled atmosphere container of claim 12, the kit of parts of claim 14, or the non-transitory computer-readable storage medium of claim 19.
